(19) United States
(12) Patent Application Publication
(10) Pub. No.: US 2007/0250291 A1
(43) Pub. Date: Oct. 25, 2007

(54) Using equivalence points to compare athletic performances across distance, gender, exact age, event and course differences

(76) Inventor: Stephen A. Beale, (US)

Correspondence Address: Dr. Stephen A. Beale, 1300 Forest Oak Ct, Bel Air, MD, 21015, US

(21) Appl. No.: 11/408,891

(22) Filed: Apr. 24, 2006

(51) Int. Cl. G21C 17/00

(52) U.S. Cl. 702/182

(57) ABSTRACT

Hundreds of thousands of youths participate in racing sports in the United States. Racing sports, such as swimming, track and speed skating all use elapsed time as the primary measure of achievement. But an elapsed time by itself, such as 55.23 seconds, is of little value in determining if a particular performance was “good.” A “good” time for one age, gender, event, distance and/or race condition might not be a “good” time under a different set of factors. Various time standards have been created to rank athletic performances. These standards are generally set up to evaluate the performances of athletes within an age group which typically ranges from one to two years. Unfortunately, athletic performances vary widely within such age groups. It is very difficult to compare the performances of two athletes who have an age difference of a few months. The methodologies described herein will overcome the inherent approximations in these existing performance standard systems. My methodology will calculate an exact age-adjusted point value for a given performance. Given this exact, age-adjusted point value for the elapsed time of a specific race, my methodology will then be able to convert that elapsed time to the expected elapsed time of an equivalent performance under a different set of factors (for example, a different event, length, course, age and/or gender).

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

Hundreds of thousands of youths and adults participate in racing sports in the United States. Racing sports, such as swimming, track and speed skating all use elapsed time as the primary measure of achievement. But an elapsed time by itself, such as 55.23 seconds, is of little value in determining if a particular performance was “good.” Obviously a “good” time at one distance, like the 200 yard freestyle swim, will probably not be a good time at a shorter distance, like the 100 yard freestyle swim. Furthermore, a good time for a male may or may not be a good time for a female. A good time for a twelve year old may or may not be a good time for a fifteen year old. A good time for the breaststroke may not be a good time for the freestyle swim. A good time for a run on an indoor track may not be a good time on an outdoor track. Thus the factors of distance, gender, age, type of event (for example, in swimming: freestyle, backstroke, breaststroke, butterfly and medley) and course/race characteristics (which may include course type, weather conditions, equipment restrictions, handicaps, etc.) all affect the measured time of a race. It is impossible to directly compare athletic performances, whether by the same person or by different people, unless all these factors are taken into account.

Various methods have been devised as an aid in determining the quality of a given performance. USA Swimming (www.usaswimming.org) has created time standards for each event, length, course, gender and age group. The time standards are, in order of increasing performance level, C, B, BB, A, AA, AAA, AAAA and NRT (national recognition time). For example, as of 2005, the time required to achieve an AAAA time standard for the backstroke, at 200 meters, in a 50 meter pool, for a girl who is 11 or 12 years old is 2:38.09 (2 minutes, 38.09 seconds). Tables that show the required time for each event/length/course/gender/age group can be found on the USA Swimming website. These “alphabetical” time standards have been one of the primary motivational tools for swimmers for many years. FIG. 1 displays a section of one of USA Swimming's time standards charts.

The main problem with these time standards is that they are based on two year age groups. Thus, a swimmer on his 11^{th} birthday is judged the same as a swimmer who is one day before his 13^{th} birthday. They both are in the 11-12 age group. A swimmer who has trained hard and is able to swim a AAA time on the day before her 11^{th} birthday often find herself demoted to a BB time the following day! In terms of motivation, it is extremely difficult for young athletes to work hard to obtain a particular standard, only to see themselves drop several levels when they “age up” to the next age group. Every year many swimmers give up the sport because of this problem.

Another problem is the comparison and competition between two athletes. It is inherently unfair for a boy who is almost 13 to race against a boy who just turned 11. This unfairness extends to all the factors listed above. A female should not be expected to race against a male. One runner in a race should not be expected to run further than the others. One swimmer should not have to swim breaststroke while another swims freestyle. One speed skater should not have to race on a short track while a different skater (in the same race) skates on an adjacent long track. In a typical competition, all of these factors are held constant for a particular race except for the age. Athletes are routinely forced to compete against other athletes within a relatively broad age range. Therefore the outcome of many races is more an accident of birthdates than an accurate measure of performances. As an example, at the most recent Maryland State Swimming Championships, a girl just a few weeks shy of 13 years old beat a girl who was one week past her 12^{th} birthday in the 400 medley for girls aged 11-12. If the championship had been held a few weeks later, the older girl would have had to swim with the 13-14 year old girls and would have finished in 7^{th} place and the younger girl would have won the event for the 11-12 year old girls! Furthermore, using the techniques patented herein, it can be shown that the younger girl's swim was actually a significantly better performance, even though all existing ranking methodologies would rate the older girl's performance equal to or better than the younger girl's performance. This tendency to reward athletes with the “right” birthdays has pronounced effects. A quick check of the most recent US Open Swimming championships (a championship for older, Olympic-caliber athletes) reveals that 7 of 10 of the women's event winners had birthdays in the three month period (late April through late July) that follows the date of the major championship meets for youth in USA Swimming. This is not surprising; swimmers born in the several months preceding these championships “age up” to the next age group every year just before the championship meets during their youth. They are forced to swim against older athletes, become discouraged, do not receive the positive feedback that comes from doing well at these championship meets, and consequently many quit the sport at a relatively early age, or do not pursue the sport with as much dedication as those athletes with “better” birthdates.

It is also desirable to be able to compare performances in which factors other than age are different. The most common example of this in swimming is the need to compare a swim in a 25 yard pool to a swim in a 50 meter pool. Conversions between the two are often needed. For example, qualification times for a particular event might be given in terms of one type of course, but the swimmer's most recent performance in the event was on a different type. Conversion calculators are available (for example, see the online calculator on the Colorado Swimming website at www.csi.org/coursealti.asp). Unfortunately, these calculators are notoriously inaccurate. Among other factors, they do not take into account the age of the athlete. Beyond course differences, it is often desirable, from motivational and training standpoints, to compare two different athletes. For example, a track coach might like to compare the progress of a female 1500 meter specialist to a male 200 meter specialist. A 10 year-old boy might like to compare his best swim in his favorite stroke with his 14 year-old sister's best swim in her favorite stroke.

A step towards alleviating these problems has been taken in the swimming world. Hy-Tek Ltd. Sports Software (www.hy-tekltd.com), in conjunction with USA Swimming, has created the Power Point tables. Briefly, these Power Point tables specify the assignment of a point value from 1 to 1100 for each swimming performance. The central idea behind the Power Points is that a swim assigned a certain number of points at one event/distance/gender/course/age group should be equivalent from a performance standpoint to any other swim that is assigned the same number of points, even if the event, distance, gender, course or age group changes. Thus, a 1000 point swim by Olympian Michael Phelps in the 200 meter Medley in a 50 meter pool would be judged equivalent (from a performance standpoint) to a 1000 point swim by a 10 year old girl in the 50 yard freestyle swum in a 25 yard pool. The Power Points take into account the various factors described above. A different table is used for each event, distance, course, gender and age group. FIG. 2 shows a portion of one of the power Point tables.

The advantage of Power Points over the old alphabetical time standards is that the Power Point rating is much more fine grained than the time standards. There are seven of the alphabetical time standards. There are 1100 Power Points. This is a major factor in enabling the methodology described in this patent. The Power Points used by USA Swimming are also superior to the older time standards in that they utilize one year age groups instead of two year age groups. Thus there is a table for 10 year olds, one for 11 year olds, etc. This is a great improvement over the two year age groups, but it is still not nearly enough. For example, a 100 yard backstroke swum by a girl in a 25 yard pool a day before her 12^{th} birthday in 1:10 would yield 744 points, while the same swim a day later would only yield 625 points. Given that the majority of swims in USA Swimming competitions fall between 450 and 750 points, this is a very large difference for two swims a day apart! Certainly the girl did not become a significantly worse swimmer overnight!

This patent describes a methodology that can be used for any racing sport in which it might be desirable to compare different performances. Performances might be affected by any of the factors listed above, or by other unforeseen factors. The only prerequisite that the methodology described herein requires is some pre-existing point system that assigns a value to a particular performance. This point value must be approximately equivalent for all races at the same performance level. A point system such as this might not even currently exist for some sports; I am patenting the methodology that will take advantage of the point system if and when it does exist. Hereafter I refer to such a point system as “equivalence points.” In order for my methodology to be of any value beyond the original equivalence points, the assignment of equivalence points by the prerequisite system will use some sort of age group approximation. For example, for the swimming Power Points, the approximation is that age groups of one year are used. Thus, the swimmer who is exactly 12 years old will use the same Power Point chart as the swimmer who is 12 years and 364 days old. I will claim that the methodology described herein can be used to determine exact age-adjusted point values in which the age approximation is removed. I will also have sub-claims that are dependent on the central claim in which this ability to determine exact age-adjusted point values can then be used to accurately convert a time under one set of factors (for example, in a swimming event: course, length, gender and exact age) to the equivalent time for a different set of factors.

To simplify the specification below, hereafter I will exemplify my claims using swimming as an example. I must emphasize, however, that this methodology can be used for any racing sport, including sports like horse and dog racing where the “athletes” are animals.

### BRIEF SUMMARY OF THE INVENTION

The methodologies that I patent herein will overcome the inherent approximations in existing equivalence point systems that are used to rank athletic performances. For example, instead of using the same Power Point chart for all swimmers in a one year age group, my methodology will calculate an exact age-adjusted point value. Given this exact, age-adjusted point value for the elapsed time of a specific race, my methodology will then be able to convert that elapsed time to the expected elapsed time of an equivalent performance under a different set of factors (for example, a different event, length, course, age and/or gender).

### BRIEF DESCRIPTION OF THE INCLUDED FIGURES

The figures included in this patent application on pages 25-38 are enumerated below:

FIG. 1: Alphabetical times standards for 10&under girls for a 50 meter pool.

FIG. 2: A Power Point chart for 200 backstroke, female, age 12, 25 yards (SCY).

FIG. 3: An interface for specifying the athlete's name and date of swim.

FIG. 4: A Power Point chart for 200 backstroke, female, age 11, 25 yards (SCY).

FIG. 5: A Power Point chart for 200 backstroke, female, age 12, 50 meters (LCM).

FIG. 6: A Power Point chart for 200 backstroke, female, age 11, 50 meters (LCM).

FIG. 7: An example interface for implementing the patented methods.

FIG. 8: An example of converting from one athlete to another with the same date of swim.

FIG. 9: An example of converting from one athlete to a different athlete with a different event.

FIG. 10: An example of converting to a different date with the same athlete.

FIG. 11: An example of converting from one course to another with the same athlete.

FIG. 12: An example of converting from an athlete with one age and gender to an athlete with a different age and gender.

FIG. 13: An example of converting from one event to another with the same athlete.

FIG. 14: A USA Swimming web page report of an athlete's swims for a time period.

FIG. 15: The conversion of data from FIG. 14 to equivalent times for a 50 meter pool (long course).

FIG. 16: Portion of the “regular” meet results.

FIG. 17: Meet results of FIG. 16 converted to exact age-adjusted equivalence points.

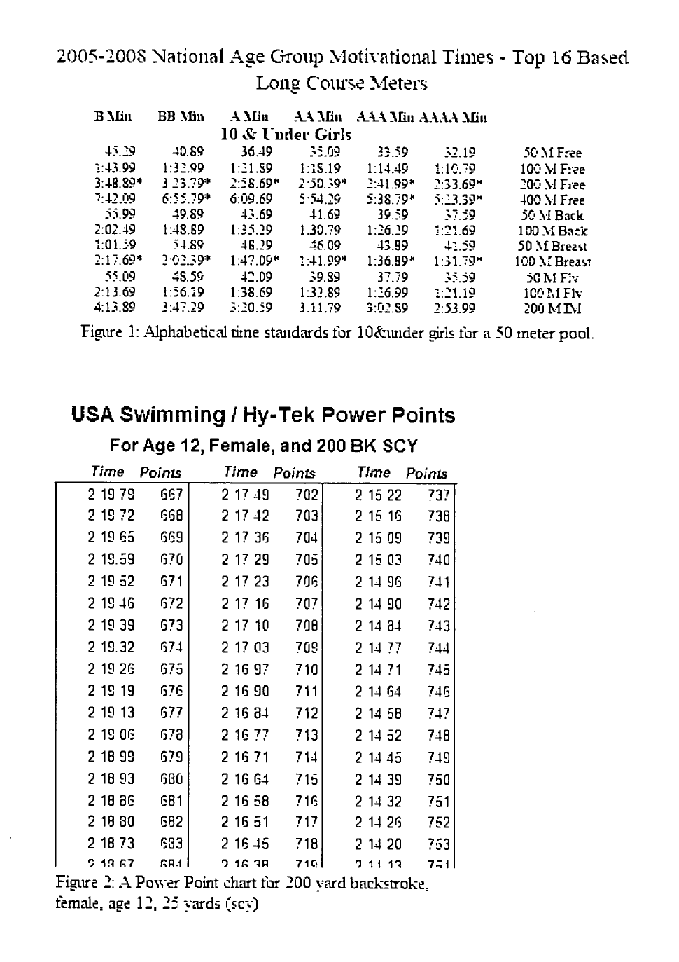

### DETAILED DESCRIPTION OF THE INVENTION

A computer program listing is included in Appendix A. The techniques patented herein will be described in two stages. First, the number of exact age-adjusted equivalence points will be computed. Paragraphs 15 through 25 describe stage one and correspond to the function get-powerpoints-for-swimmer in Appendix A. Second, the elapsed time under one set of factors will be converted to an elapsed time for a different set of factors. Paragraphs 26 through 35 describe stage two and correspond to the function get-time-for-swimmer in Appendix A. Following the description of the methodology, the human interface of the computer program that has been implemented will be described. Paragraphs 36 through 46 describe the interface and exemplify a subset of the potential uses of the patented methodologies.

The inputs to the first stage are the elapsed time and a description of the other relevant factors. For swimming, the factors include the distance, gender, age (accurate to any desired degree, typically to the day), event (freestyle, backstroke, breaststroke, butterfly or medley) and course (25 yard, 25 meter or 50 meter pool). The output of the first stage will be the exact age-adjusted equivalence points. Call this output EP-Exact. Paragraph 17 specifies exactly the variable names for each input.

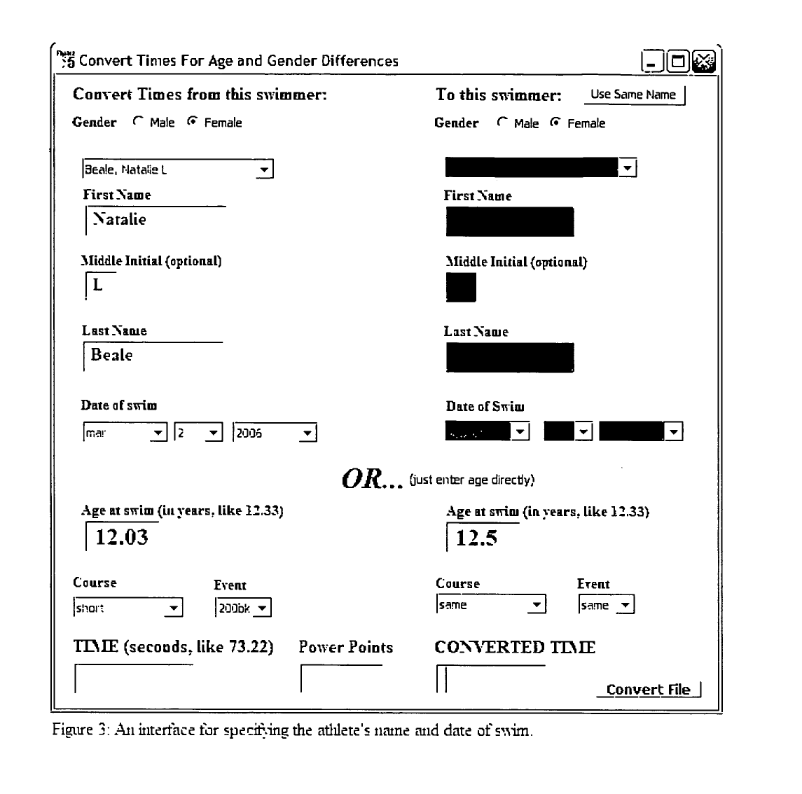

In a practical application, a convenient method for determining the athlete's age on the date of the performance is necessary. The method for determining this age is not strictly a part of this patent, but the computer program that implements the central methodologies of this patent and is demonstrated herein does contain a method for determining the athlete's age on the date of the swim. Specifically, an interface is provided for looking up the swimmer's name in a database which contains the swimmer's birth date. The user then inputs the date of the swim, after which the program calculates the swimmer's age on that date, accurate to the day. The interface also allows the user to bypass the above functionality and enter the athlete's age directly. FIG. 3 displays one interface that could be used in a practical application. It is shown in the state after the user has chosen an athlete's name and entered the date of the swim. The age is computed and displayed automatically, as shown. In what follows, I will simply state that one of the inputs to the program is the athlete's age on the date of the swim; I will assume some sort of convenient method for determining that age.

The inputs for a swimming example are given below; the variable names used for each are as shown:

Elapsed-Time: 2:14.21 (two minutes, 14.21 seconds)

Distance: 200 yards

Gender: female

Age: 12.03 years

Event: backstroke

Course: 25 yard

Step one of the algorithm for the first stage. Round the input Age to the nearest integer that is equal to or less than Age. Call this Age-Upper. For the example, Age-Upper=12

Step two. Using the existing equivalence points table appropriate for Distance, Gender, Age-Upper, Event and Course, determine the number of equivalence points for Elapsed-Time. Call this EP-Upper. The pre-existing equivalence points tables for swimming use one year age groups. FIG. 2 shows a portion of the table for the factors=200 yard backstroke, female, 12 year old, 25 yard course. To determine EP-Upper, find the entry in the table corresponding to the greatest time that is less than or equal to the input Elapsed-Time. For this example, Elapsed-Time=2:14.21; this gives EP-Upper=753.

Step three. Subtract one from Age-Upper. Call this Age-Lower. For the example, Age-Lower=11.

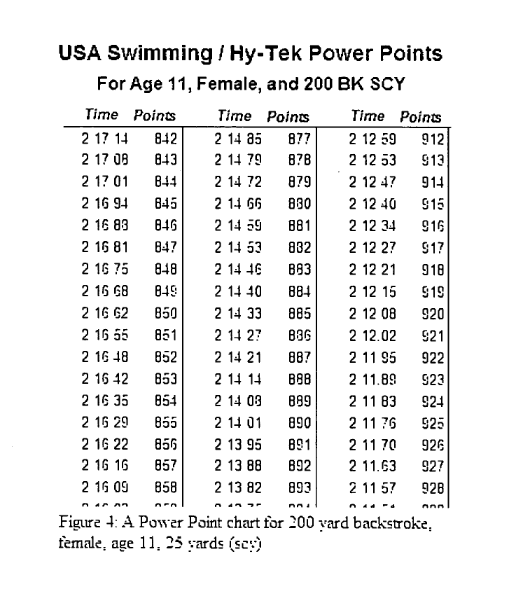

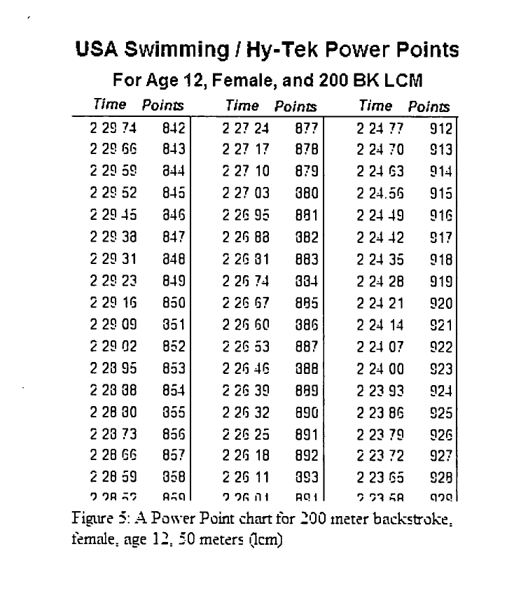

Step four. Using the existing equivalence points table appropriate for Distance, Gender, Age-Lower, Event and Course, determine the number of equivalence points for Elapsed-Time. Call this EP-Lower. FIG. 4 shows a portion of the table for the factors=200 yard backstroke, female, 11 years old, 25 yard course. To determine EP-Lower, find the entry in the table corresponding to the greatest time that is less than or equal to the input Elapsed-Time. For this example, Elapsed-Time=2:14.21; this gives EP-Lower=887.

Before describing the final step, I will interpret the meaning of EP-Upper and EP-Lower. The equivalence point table for 12 year olds are used within USA Swimming for all athletes who are 12 years old, up to and including athletes who are 12 years and 364 days old. Typically, an athlete will significantly improve during the 365 days that he or she is 12 years old. It follows that the athlete's best times for the year will most commonly occur closest to his or her 13^{th} birthday. Thus, the athletes who are closest to 12 years and 364 days old will, on the average, attain higher equivalence points than younger 12 year old athletes. The main point is that the 12 year old equivalence point tables really are most applicable to the athlete who is 12 years and 364 days old. All 12 year old athletes who are younger than that will be at a disadvantage because the younger athletes have to use the same table as the older athlete. To simplify the specification a little, I assume that the 12 year old tables should be used without modification for an athlete who is exactly 13.0 years old (instead of, more correctly, being used for an athlete who is 12 years and 364 days old). This simplification is a pedagogical matter only; this patent covers implementations that use the more correct formulation. Therefore, EP-Upper, in this example, corresponds to the exact number of equivalence points for an athlete who is exactly 13 years old because it came from the pre-existing tables for a 12 year old. EP-Lower corresponds to the exact number of equivalence points for an athlete who is exactly 12 years old because it came from the pre-existing table for 11 year olds. The athlete in the example is between 12 and 13 years old; step 5 will now determine the exact age-adjusted equivalence points for her using interpolation.

Step five. Determine the output for the first stage, EP-Exact. For the example, we have calculated EP-Upper=753. This corresponds to the athlete who is 13.0 years old. We have calculated EP-Lower=887. This corresponds to the athlete who is 12.0 years old. The actual, exact input age of the athlete in the example is 12.03 years, or Age=12.03. To determine EP-Exact, interpolate between the points (887, 12.0) and (753, 13.0) to find the output EP-Exact in the point (EP-Exact, 12.03). This patent does not specify the exact function used to interpolate. For different sports (or even different users within a sport), different interpolation functions might be more desirable. The most simple interpolation would be a straight-line interpolation. For swimming, the younger the swimmer the more rapid the improvement. The following paragraph describes an interpolation function that displays this behavior. I must emphasize that the interpolation function described is only given as an example; this patent will cover any interpolation function.

An example interpolation function that is appropriate for swimming is described. The inputs to the interpolation function, along with input values for the example, are shown below.

Inputs:

EP-Upper=753

EP-Lower=887

Age-Lower=12.0

Age=12.03

This function assumes that Age-Lower is always one year less than Age-Upper, as is appropriate for swimming. For other sports, the age differences might be more or less, in which case modifications to this interpolation function would need to be made. Again, this interpolation function is only given as an example; my claims extend to any interpolation function desired.

Output:

EP-Exact

Function description:

EP-Straight-Line=(−EP-Lower (*(−EP-Lower EP-Upper)(−Age Age-Lower)))

EP-SQRT=(−EP-Lower(*(−EP-Lower EP-Upper)(SQRT(−Age Age-Lower))))

EP-Exact=(round(/(+EP-Straight-Line EP-Straight-Line EP-SQRT) 3.0))

EP-Straight-Line corresponds to the straight-line interpolation. EP-SQRT corresponds to an interpolation which mimics the curve of the square root function between 0 and 1. In practice, I have found that the overall best interpolation is an average of these two, with twice as much weight given to the straight-line interpolation, as shown. For the example, the following values are obtained:

EP-Straight-Line=(−887(*(−887 753)(−12.03 12.0)))=882.98

EP-SQRT=(−887(*(−887 753)(sqrt(−12.03 12.0))))=863.79

EP-Exact=(round((+882.98 882.98 863.79)3.0))=877

Thus the output of the first stage, which corresponds to the exact age-adjusted equivalence points, is 877.

The second stage of the methodology patented herein converts the input Elapsed-Time, which was achieved under one set of factors that were specified in the inputs to stage 1, to the expected time for an equivalent performance under a different set of factors. The output of stage two will be Converted-Time. The inputs to the second stage are EP-Exact, which was calculated in the first stage (for the example, EP-Exact=877), and a specification of the factors that describe the circumstances that would apply to the converted time. For swimming, the factors include the distance, gender, age accurate to any desired degree, typically to the day), event (freestyle, backstroke, breaststroke, butterfly or medley) and course (25 yard, 25 meter or 50 meter pool). For this example, assume the user would like to convert the original elapsed time that was input to stage 1 (and which was swum with these factors: 200 yards, female, 12.03 years, backstroke, 25 yard course) to the following factors (with the variable names as shown):

Conversion-Distance: 200 yards

Conversion-Gender: female

Conversion-Age: 12.5 years

Conversion-Event: backstroke

Conversion-Course: 50 meter

A desire for this kind of conversion is fairly common. Perhaps the athlete would like to know what the expected time for an event at an upcoming swim meet would be. Note that in this case the only factors that have changed from the original factors are the age and the course type. In general, any or all of the factors can be changed; the steps outlined below remain the same. The only difference being as to which of the existing Power Point tables will be used.

As was discussed above, a practical application must provide a convenient mechanism for determining Conversion-Age, the age of the athlete on the date of the swim to be converted. The computer program demonstrated herein provides such a mechanism, as described above in paragraph 16 and displayed in FIG. 3. In FIG. 3, note that the “Age at Swim” box in the right column was filled in directly by the user with a value of 12.5, reflecting the fact that the user, in this example, would like to convert the performance in the left column to an equivalent performance by a 12.5 year old. This is the value that will be assigned to Conversion-Age. Alternately, the user could have entered a swimmer's name and the date of the swim, and the program would have automatically calculated Conversion-Age.

Step one of the algorithm for the second stage. Round Conversion-Age to the nearest integer that is equal to or less than the input age. Call this Conversion-Age-Upper. For the example, Conversion-Age-Upper=12.

Step two. Using the existing equivalence points table appropriate for Conversion-Distance, Conversion-Gender, Conversion-Age-Upper, Conversion-Event and Conversion-Course, determine the elapsed time corresponding to EP-Exact. Call this Converted-Time-Upper. FIG. 5 shows a portion of the table for the factors=200 yard backstroke, female, 12 year old, 50 meter course. To determine Converted-Time-Upper, find the entry in the table corresponding to EP-Exact. For this example, EP-Exact=877; this gives Converted-Time-Upper=2:27.24.

Step three. Subtract one from Conversion-Age-Upper. Call this Conversion-Age-Lower. For the example, Conversion-Age-Lower=11.

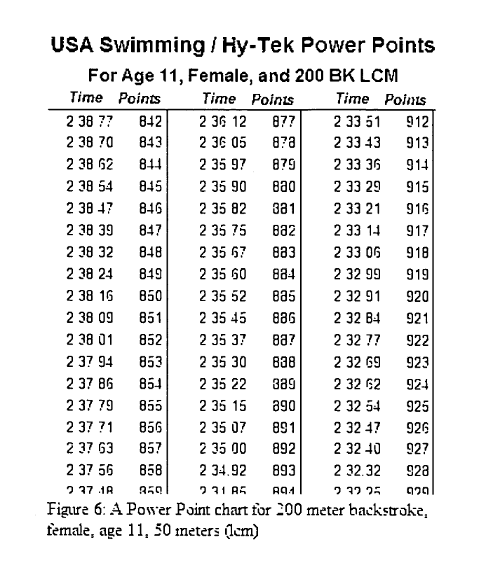

Step four. Using the existing equivalence points table appropriate for Conversion-Distance, Conversion-Gender, Conversion-Age-Lower, Conversion-Event and Conversion-Course, determine the elapsed time corresponding to EP-Exact. Call this Converted-Time-Lower. FIG. 6 shows a portion of the table for the factors=200 yard backstroke, female, 11 year old, 50 meter course. To determine Converted-Time-Lower, find the entry in the table corresponding to EP-Exact. For this example, EP-Exact=877; this gives Converted-Time-Lower=2:36.12.

As discussed above, in this methodology the existing equivalence tables for age=11 actually are appropriate for athletes who are exactly 12 years old. Thus, for this example, Converted-Time-Lower is the time needed for an athlete who is exactly 12 years old to attain 877 equivalence points. The existing equivalence tables for age=12 are appropriate for athletes who are exactly 13 years old. Thus, for this example, Converted-Time-Upper is the time needed for an athlete who is exactly 13 years old to attain 877 equivalence points. The athlete in the example is between 12 and 13 years old. Step five will convert the exact Converted-Time for this athlete using interpolation.

Step five. Determine the output for the second stage, Converted-Time. For the example, we have calculated Converted-Time-Upper=2:27.24. This corresponds to the athlete who is 13.0 years old. We have calculated Converted-Time-Lower=2:36.12. This corresponds to the athlete who is 12.0 years old. The actual, exact input age of the athlete for this stage of the example is 12.5 years, or Age=12.5. To determine the output Converted-Time, interpolate between the points (2:36.12, 12.0) and (2:27.24, 13.0) to find the output Converted-Time in the point (Converted-Time, 12.5). As discussed above, this patent does not specify the exact function used to interpolate. For different sports (or even different users within a sport), different interpolation functions might be more desirable. The most simple interpolation would be a straight-line interpolation. For swimming, the younger the swimmer the more rapid the improvement. The following paragraph describes an interpolation function that displays this behavior. I must emphasize that the interpolation function described is only given as an example; this patent will cover any interpolation function.

The interpolation function shown below is similar to the interpolation function already described above. Here, the variables will correspond to elapsed times instead of equivalence points. The inputs to the interpolation function, along with input values for the example, are shown below.

Inputs:

Converted-Time-Upper=2:27.24 (147.24 seconds)

Converted-Time-Lower=2:36.12 (156.12 seconds)

Age-Lower=12.0

Age=12.5

Note that a practical implementation of this methodology will need to convert input times given in minutes and seconds to seconds only, as shown. This interpolation function assumes that Age-Lower is always one year less than Age-Upper, as is appropriate for swimming. For other sports, the age differences might be more or less, in which case modifications to this interpolation function would need to be made. Again, this interpolation function is only given as an example; my claims extend to any interpolation function desired.

Output:
Converted-Time
Function description:
CT-Straight-Line =

(− Converted-Time-Lower

(* (− Converted-Time-Lower Converted-Time-Upper)

(− Age Age-Lower)))

CT-SQRT =

(− Converted-Time-Lower

(* (− Converted-Time-Lower Converted-Time-Upper)

(SQRT (− Age Age-Lower))))

Converted-Time=(/(+CT-Straight-Line CT-Straight-Line CT-SQRT) 3.0) CT-Straight-Line corresponds to the straight-line interpolation. CT-SQRT corresponds to an interpolation which mimics the curve of the square root function between 0 and 1. In practice, I have found that the overall best interpolation is an average of these two, with twice as much weight given to the straight-line interpolation, as shown. For the example, the following values are obtained:
CT-Straight-Line=(−156.12 (*(−156.12 147.24) (−12.5 12.0)))=151.68
CT-SQRT=(−156.12(*(−156.12 147.24) (sqrt (−12.512.0)))) 149.84
Converted-Time=(/(+151.68151.68149.84)3.0)=151.07(2:31.07)

Thus the output of the second stage, which corresponds to the expected elapsed time for a performance equal to the performance input to the first stage but swum under the factors input to the second stage, is 2:31.07. So, the female athlete who swam the 200 yard backstroke in a 25 yard pool at age 12.03 in 2:14.21 would be expected to swim the 200 meter backstroke in a 50 meter pool at age 12.5 in 2:31.07 in order to achieve an equivalent performance.

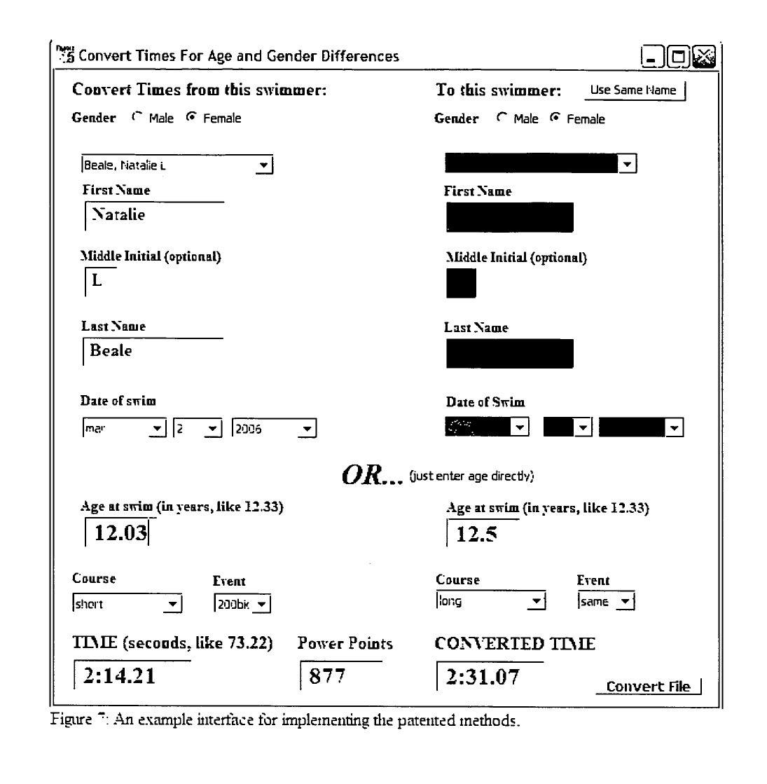

FIG. 7 displays the interface for a program that implements this methodology using the example inputs. In FIG. 7, the user has input the gender, name, event, distance, course, date of swim and elapsed time of the original performance on the left side. After this data is entered, the program will display the corresponding exact age-adjusted equivalence points, in this case 877. Then the user entered the information for the desired conversion. For this example, the only changes were the athlete's age and the course, which was changed to “long” (a 50 meter pool). The program then displayed the converted time (2:31.07).

The methodology patented herein will enable the conversion of any elapsed time under any set of factors to the expected time for an equivalent performance under a different set of factors. The specification for the methodology is complete; however, I will present some examples of how the methodology can be used along with the interface for a computer program that implements the methodology for those examples.

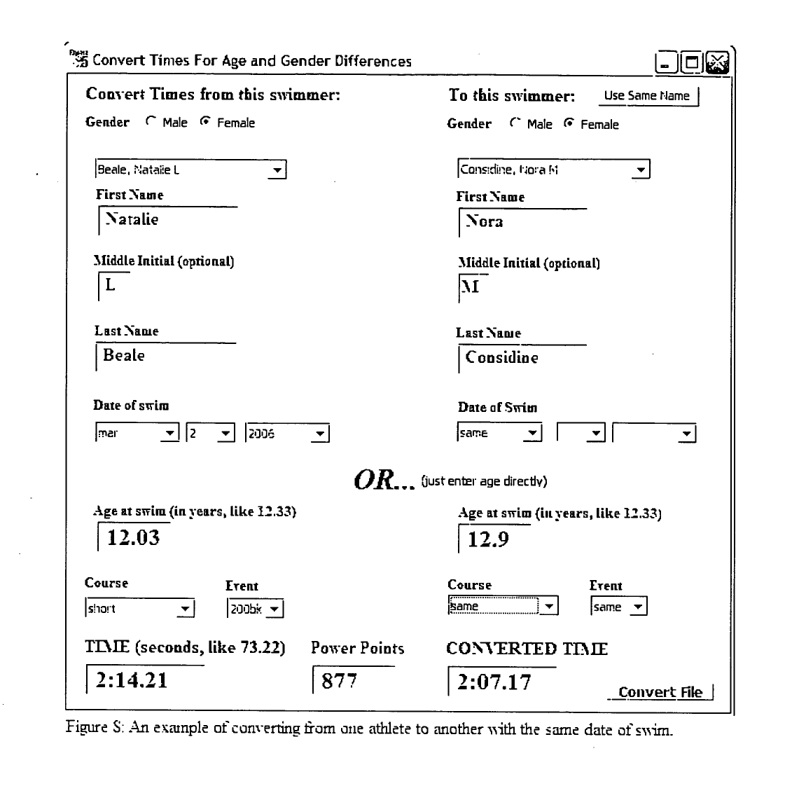

FIG. 8 shows that a time for one athlete on a particular date can be converted to the time for a different athlete in the same event on the same date. This is useful for comparing the performances of two athletes.

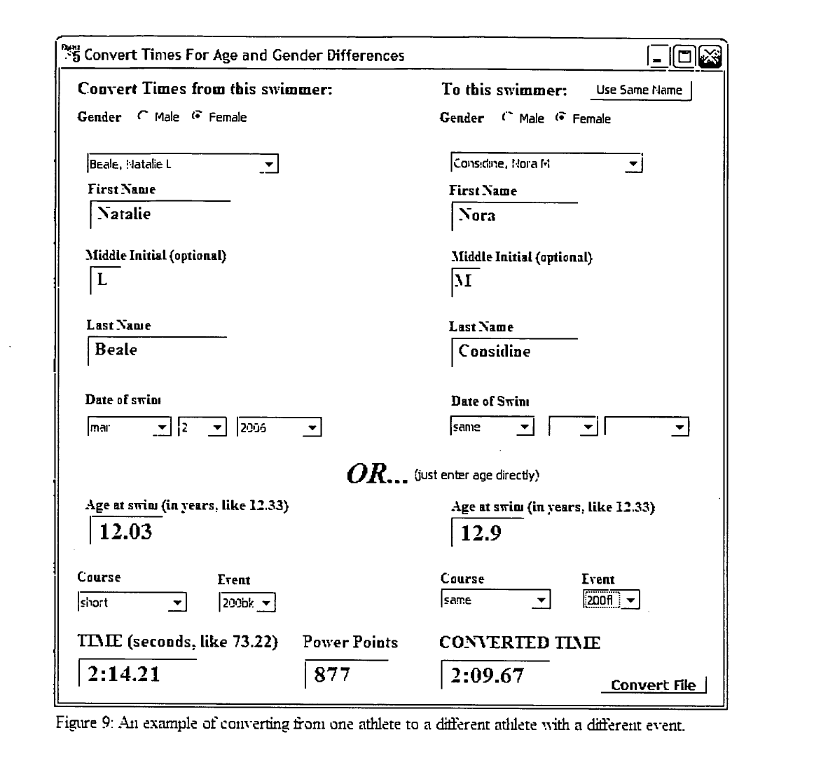

FIG. 9 shows that a time for one athlete can be converted to the time for a different athlete in a different event. This is useful for comparing the relative performances of two athletes in different events.

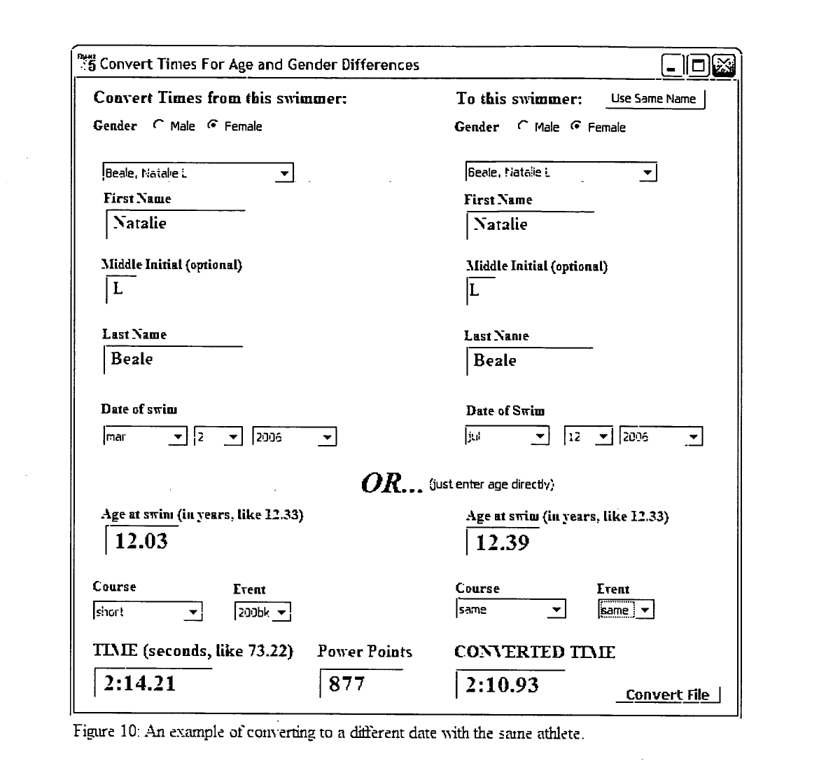

FIG. 10 shows that a time for one athlete can be converted to the time for the same athlete on a later date. This is useful for predicting a time in a future event. It is also useful for a coach who would like to track the progress of a swimmer over time, to determine whether the athlete is swimming at the same performance level as in the past.

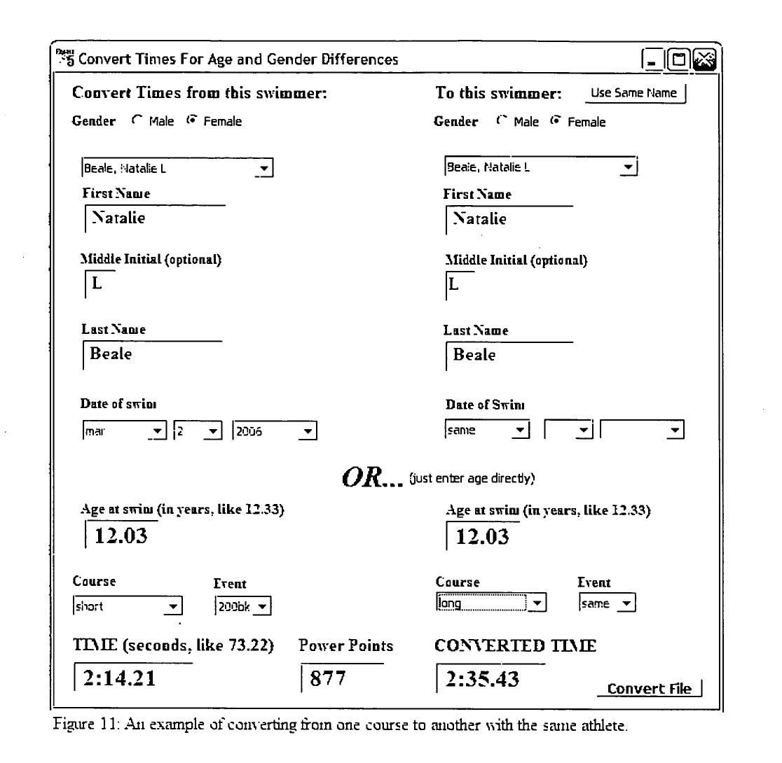

FIG. 11 shows that a time for an athlete can be converted to a time on a different course. This type of conversion is frequently needed in swimming.

FIG. 12 shows that a time for an athlete of one gender and age can be converted to the time that an athlete of a different gender and age would need to attain the same performance. This is useful for comparing athletes of different genders.

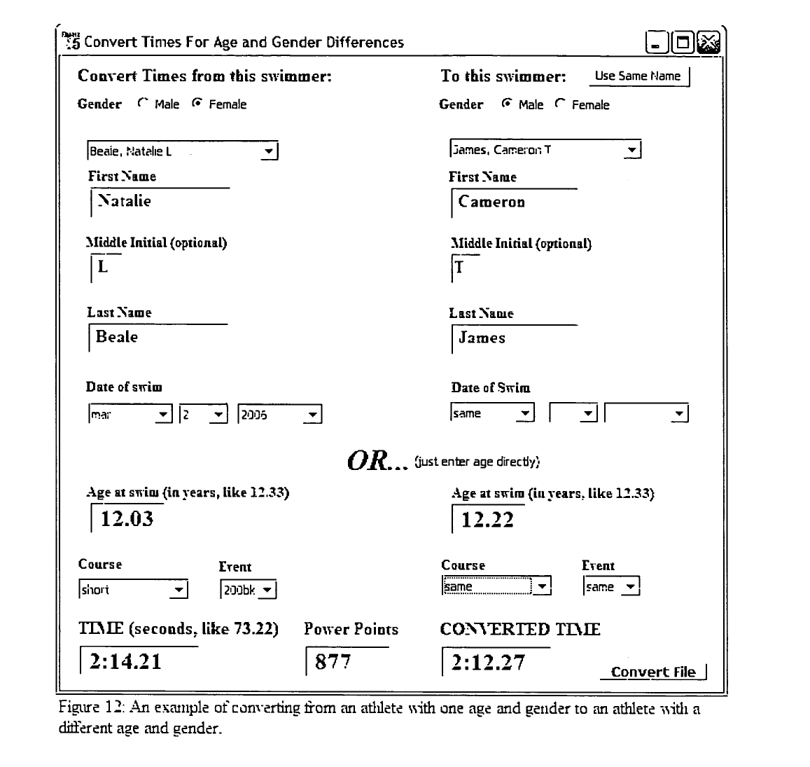

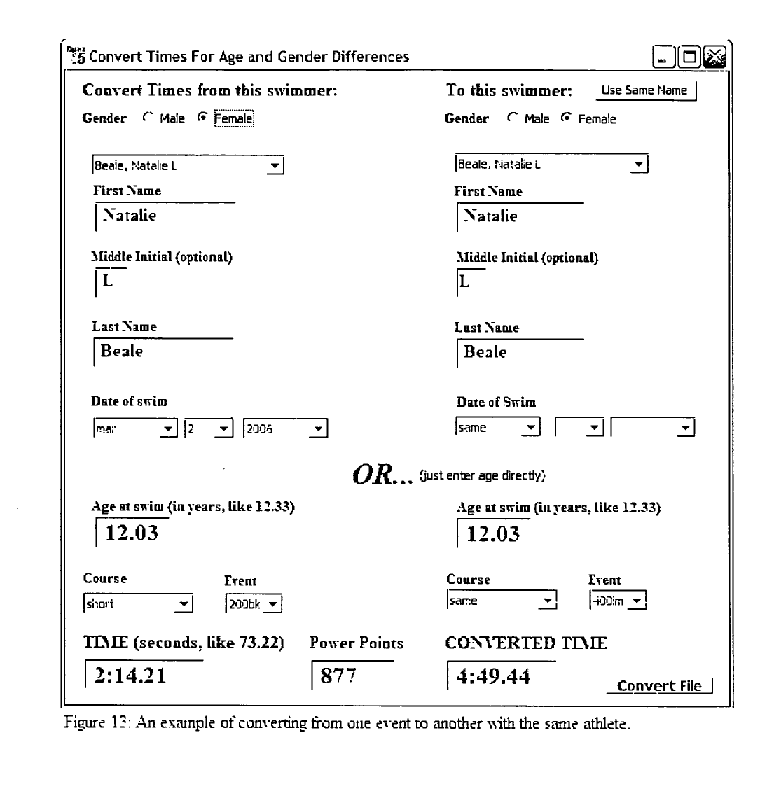

FIG. 13 shows that a time for an athlete in one event can be converted to the time that the same athlete would need for a different event to attain the same level of performance. This is useful to determine whether an athlete needs more training in a particular event.

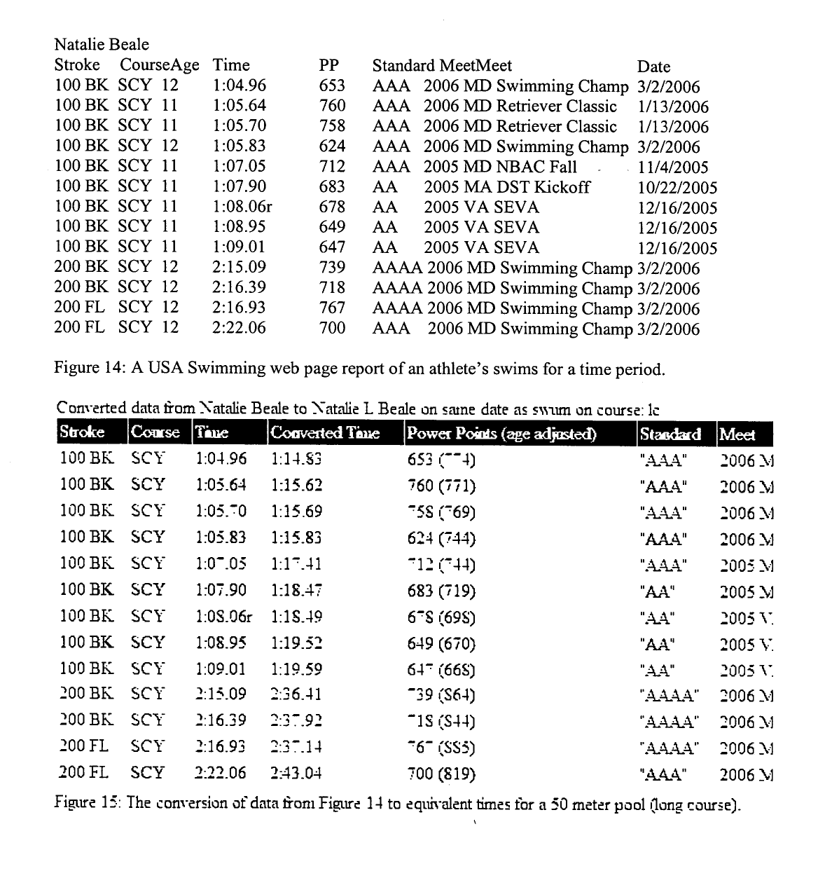

FIG. 14 shows a portion of a USA Swimming web report for a swimmer. All of the elapsed times for swims during a particular time period are displayed, along with the number of Power Points (from the pre-existing Power Point tables which reflect one year age groups) and the alphabetical time standard for each swim. The program that implements the methodology patented herein includes a mechanism for converting the times reported in these USA Swimming web pages to times that would reflect equivalent performances under a different set of factors. The user uses the interface shown in the previous figures to set up the factors for the conversion. On the right side of the interface, the user can enter any name, gender, date of swim, age, course or event, then click on the “Convert File” button, and the program will produce a new file that displays the exact age-adjusted equivalence points for each swim along with the converted times. For example, FIG. 15 is the file output for the same swimmer shown in FIG. 14, except that the course is changed to a 50 meter “long course.”

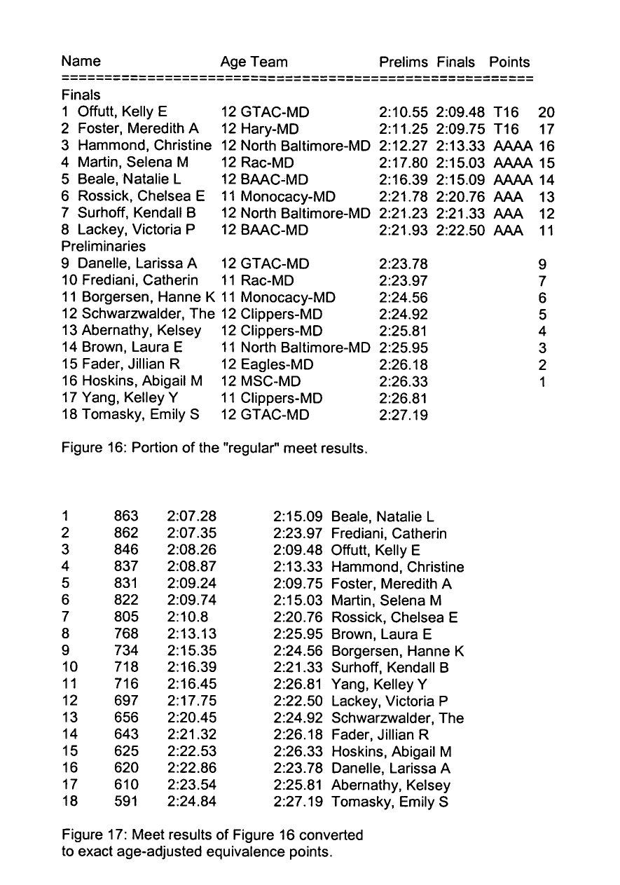

One of the best applications these methods can be used for is to convert meet results. The program that implements the methodology patented herein includes a mechanism for converting the times reported in the standard meet results html file. FIG. 16 shows the results of the finals of one event in the 2006 Maryland State Short Course Championships. These are the “regular” results, based on the elapsed time. FIG. 17 shows the converted results, based on the exact age-adjusted equivalence points for each swimmer. As is evident, the order of swimmers is not the same. In FIG. 17, the first column is the order of finish based on the age-adjusted equivalence points. Column two shows the number of exact age-adjusted equivalence points for each swim. The times in column three were obtained using the time conversion methodologies described in this patent. For each swimmer, their actual elapsed time is converted to the time of an equivalent performance for an athlete whose age is the oldest that the event allows. For the event in FIGS. 16 and 17, the age group is 11-12, so the times in column three correspond to the times that an athlete who is 12 years, 364 days old would achieve for an equivalent performance. Column four displays the actual elapsed time. FIGS. 16 and 17 are perhaps the best arguments in favor of the methodology described in this patent. The “regular” results are comparing “apples with oranges.” As stated previously, it is really impossible to compare two athletes of different ages, especially for athletes under 16 years of age, because even a few months makes a large difference. These figures demonstrate that it is possible to compare “apples with apples” using the methods described herein.

The examples of the previous section are not meant to be exhaustive. They are only representative of the types of conversions possible using the methodologies patented herein. Furthermore, the computer interface described herein is included chiefly as an aid in presenting the material. This patent covers the methodology for determining the exact age-adjusted equivalence points for a performance (stage one of the algorithm described above) and the methodology for converting the elapsed time for a performance under one set of factors to the expected elapsed time for an equivalent performance under a different set of factors (stage two of the algorithm described above). All interfaces and computer programs that implement these methodologies will be constrained by the laws pertaining to this patent. Furthermore, the methodologies patented herein apply to any racing sport where elapsed time is used as a measure of performance.

### Appendix A

### Computer Listing

;;get-powerpoints-for-swimmer corresponds to stage 1 of the algorithm described in paragraphs 15 through
;;25 of the patent application. get-time-for-swimmer corresponds to stage 2 of the algorithm described in
;;paragraphs 26 through 35 of the patent application. Note: a practical computer application will need to
;;include facilities for handling incorrect user inputs. These error handling facilities are not included below.
(defun get-powerpoints-for-swimmer (age event gender elapsed-time course)

;; This corresponds to stage 1 of the algorithm.
;; In this implementation, event is a combination of distance and event; for example,
;; 50fr, 100fr, 50bk, ...
;; EXAMPLE USAGE:
;; > (get-powerpoints-for-swimmer 12.03 ′200bk ′f 134.21 ′sc)
;; 877
(let* ((age-upper (− (ceiling age) 1))

(ep-upper (get-powerpoints-from-time event age-upper gender elapsed-time course))
(age-lower (− age-upper 1))
(ep-lower (get-powerpoints-from-time event age-lower gender elapsed-time course))
(ep-exact (interpolate-pp ep-lower ep-upper (− age 1) age-lower))
)

ep-exact))

(defun get-time-for-swimmer

(conversion-age conversion-event conversion-gender conversion-course ep-exact)

;; this corresponds to stage 2 of the algorithm
;; EXAMPLE USAGE:
;; > (get-time-for-swimmer 13.5 ′200bk ′f ′sc 877)
;; 124.8767
(let* ((conversion-age-upper (− (ceiling conversion-age) 1))

(converted-time-upper

(get-time-from-powerpoints conversion-event conversion-age-upper
conversion-gender ep-exact conversion-course))

(conversion-age-lower (− conversion-age-upper 1))
(converted-time-lower

(get-time-from-powerpoints conversion-event conversion-age-lower
conversion-gender ep-exact conversion-course))

(converted-time
(interpolate-time converted-time-lower converted-time-upper

(− conversion-age 1) conversion-age-lower))

)

converted-time))

(defun interpolate-pp (ep-lower ep-upper age age-lower)

(let* ((ep-straight-line (− ep-lower (* (− ep-lower ep-upper) (− age age-lower))))

(ep-sqrt (− ep-lower (* (− ep-lower ep-upper) (sqrt (− age age-lower)))))
(ep-exact (round (/ (+ ep-straight-line ep-straight-line ep-sqrt) 3.0)))
)

ep-exact))

(defun interpolate-time

(converted-time-lower converted-time-upper conversion-age conversion-age-lower)
(let* ((CT-straight-line

(− converted-time-lower

(* (− converted-time-lower converted-time-upper)

(− conversion-age conversion-age-lower))))

(CT-sqrt
(− converted-time-lower

(* (− converted-time-lower converted-time-upper)

(sqrt (− conversion-age conversion-age-lower)))))

(converted-time (/ (+ CT-straight-line CT-straight-line CT-sqrt) 3.0))
)

converted-time))

#|
Note: get-powerpoints-from-time and get-time-from-powerpoints are functions that
load the existing powerpoint table files and find the powerpoints or time
corresponding to the input time or power points, as described in paragraphs 19 and 29.
These functions are included below for completeness. Note that the information in the power point tables
could be stored in a database instead of files which would simplify the following code.
A portion of a file that contains the Power Points looks like this:
44.23 507
44.21 508
44.18 509
44.16 510
44.14 511
On each line there is a real number time (in seconds) and the corresponding integer Power Points.
There is a different file for each event/age/gender/course combination. An example of a filename is: “50fr-
11-f-sc”; this is the name of the existing Power Point table for the 50 freestyle for 11 year old females on a
short course.
|#
(defun get-powerpoints-from-time (event age gender in-time course)

;; time is in seconds, like 231.23
;; age is an integer in years, like 12
;; gender is ′m or ′f
;; event is ′50fr, ′50bk, ′100fr, etc
;; fname will be the file name of the existing Power Point table's file. For example,
;; “50fr-11-f-sc” is the name of the existing Power Point table for the 50 freestyle for
;; 11 year old females on a short course.
;; *PP-dir* is the directory in which the Power Point files are stored.
(let ((fname (concatenate ‘string *PP-dir* (prin1-to-string event) “−” (prin1-to-string age) “−”

(prin1-to-string gender) “−” (prin1-to-string course) “.txt”)))

```
  (with-open-file
  (f fname :direction :input)
  (do* ((line (read-line f nil :EOF) (read-line f nil :EOF))
```

(time/pps (get-time/pps line) (get-time/pps line))
(time (first time/pps) (first time/pps))
(pps (second time/pps) (second time/pps)))

;; exit condition:

((or (eql line :EOF) (and (numberp time) (<= time in-time)))

;; return
(if (eql line :EOF)

```
;; if in-time is less than all times in the file, return the maximum 1100
  1100
  ;; else return the number of power points associated with the
  ;; first time that is less than or equal to in-time:
  pps))))))
```

(defun get-time-from-powerpoints (event age gender in-pps course)

;; in-pps is any number in the range of 1 to 1100
;; age is an integer in years, like 12
;; gender is ′m or ′f
;; event is ′50fr, ′50bk, ′100fr, etc
;; fname will be the file name of the existing Power Point table's file. For example,
;; “50fr-11-f-sc” is the name of the existing Power Point table for the 50 freestyle for
;; 11 year old females on the short course.
;; *PP-dir* is the directory in which the Power Point files are stored.
(let ((fname (concatenate ′string *PP-dir* (prin1-to-string event) “−” (prin1-to-string age) “−”

(prin1-to-string gender) “−” (prin1-to-string course) “.txt”)))

```
(with-open-file
  (f fname :direction :input)
  (do* ((line (read-line f nil :EOF) (read-line f nil :EOF))
```

(time/pps (get-time/pps line) (get-time/pps line))
(time (first time/pps) (first time/pps))
(pps (second time/pps) (second time/pps)))

```
;; exit condition:
((>= pps in-pps)
  ;; return
  time)))))
```

(defun get-time/pps (line)

;; line can look like: “3:33.22 10” OR “33.22 10”
;; The output of this function looks like (time-in-seconds power-points),
;; for example, (213.22 10)
(cond ((eql line :EOF) nil)

(t

(let* ((colon-pos (position ′#\: line))

(min

(if (null colon-pos) 0 (read-from-string (subseq line 0 colon-pos))))

(space-pos (position ′#\Space line))
(sec (read-from-string (subseq line (if colon-pos (+ colon-pos 1) 0) space-pos)))
(pps (read-from-string (subseq line (+ space-pos 1)))))

(list (+ (* 60 min) sec) pps)))))

What is claimed is:

1. A method specified in the first stage of the algorithm in paragraphs through 25 above that calculates the exact age-adjusted equivalence points for the athletic performance specified in the inputs to the first stage of the algorithm.

2. A method specified in the second stage of the algorithm in paragraphs 26 through 36 above that utilizes the exact age-adjusted equivalence points calculated in claim 1 to calculate the expected elapsed time of an athletic performance that is equivalent to the performance specified in the inputs to the first stage of the algorithm but which is attained under the set of factors that are input to the second stage of the algorithm.

3. The computer interface and functionalities specifically exemplified in paragraphs 37 through 46 above.
